(19) United States
(12) Patent Application Publication
(10) Pub. No.: US 2003/0061915 A1
(43) Pub. Date: Apr. 3, 2003

(54) Combination tire repair wrench

(76) Inventor: Lai-Fu Wang, Tali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/964,365

(22) Filed: Sep. 28, 2001

(51) Int. Cl. B25B 23/16

(52) U.S. Cl. 81/177.6

(57) ABSTRACT

A combination tire repair wrench includes a main wrench, two auxiliary tool members respectively pivoted to two polygonal connecting rods at the ends of a crossbar being welded to a middle part of the main wrench, the auxiliary tool members each having a hexagonal head and a coupling portion extended from the head and pivoted to one connecting rod, and two locking barrels adapted to lock the auxiliary tool members in the operative position, each locking barrel having two hexagonal coupling portions at the ends of the inner diameter for engagement with the polygonal peripheral wall of one connecting rod and the polygonal head of the corresponding auxiliary tool member.

### BACKGROUND OF THE INVENTION

The present invention relates to tire repair wrenches, and more particularly, to a combination tie repair wrench, which has means to protect the auxiliary tool member thereof against deformation when driven to rotate the workpiece.

FIGS. 1˜3 shows a conventional crossed type folding collapsible combination tire repair wrench. This structure of combination tire repair wrench comprises a main wrench 1, which is an elongated tool having two hexagonal sockets at the ends, a crossbar 10 welded to the middle part of the main wrench 1, two circular connecting rods 11 respectively fixedly provided at the ends of the crossbar 10, the circular connecting rods 11 each having a substantially U-shaped coupling portion 12, two auxiliary tool members 13 respectively pivoted to the circular connecting rods 11, the auxiliary tool members 13 each having a circular shank 15, a coupling head 14 formed integral with one end of the circular shank 15 and respectively pivoted to the U-shaped coupling portion 12 of each circular connecting rod 11, and a spring-supported steel ball 16 provided in a recessed hole (not shown) in the circular shank 15 adjacent to the coupling head 14, and two locking barrels 17 respectively coupled to the auxiliary tool members 13 and moved along the circular shank 15 of the respective auxiliary tool member 13 between the locking position and the unlocking position. The locking barrels 17 each have an inner diameter 18 slightly greater than the outer diameter of the circular shank 15 of each auxiliary tool member 13. When extended out the auxiliary tool members 13, the locking barrels 17 are respectively moved to the locking position and covered over the U-shaped coupling portion 12 of each circular connecting rod 11 and the spring-supported steel ball 16 of each auxiliary tool member 13, keeping the auxiliary tool members 13 aligned in a line with the crossbar 10. This structure of combination tire repair wrench is still not satisfactory in function. Because the inner diameter 18 of each locking barrel 17 is a circular through hole, the corresponding locking barrel 17 will slip on the corresponding circular connecting rod 11 and the corresponding auxiliary tool member 13 and cannot be rotated with the respective auxiliary tool member 13 when driving the respective auxiliary tool member 13 to rotate the workpiece. Furthermore, when driving one auxiliary tool member 13 to rotate the workpiece, the corresponding the locking barrel 17 cannot protect the U-shaped coupling portion 12 of the corresponding circular connecting rod 11 against twisting force, i.e., the coupling head 14 of the respective auxiliary tool member 13 tends to be deformed.

### SUMMARY OF THE INVENTION

The present invention has been accomplished to provide a combination tire repair wrench, which eliminates the aforesaid drawbacks. It is the main object of the present invention to provide a combination tire repair wrench, which protects the auxiliary tool members against deformation during when driven to rotate the workpiece. To achieve this and other objects of the present invention, the combination tire repair wrench comprises a main wrench, a crossbar welded to the main wrench in the middle, two hexagonal connecting rods fixedly provided at the ends of the crossbar, two auxiliary tool members respectively pivoted to the connecting rods and turned between the operative position and the non-operative position within 90°, the auxiliary tool members each having a hexagonal head and a coupling portion extended from the head and pivoted to one connecting rod, and two locking barrels respectively slidably coupled to the auxiliary tool members and adapted to lock the auxiliary tool members in the operative position, each locking barrel having two hexagonal coupling portions at the ends of the inner diameter for engagement with the polygonal peripheral wall of one connecting rod and the polygonal head of the corresponding auxiliary tool member.

### BRIEF DESCRIPTION OF THE DRAWINGS

FIG. 1 is a perspective view of a combination tire repair wrench according to the prior art.

FIG. 2 shows the prior art combination tire repair wrench extended out.

FIG. 2A is a sectional view taken along line A-A of FIG. 2.

FIG. 3 is a longitudinal view in section of the prior art combination tire repair wrench.

FIG. 3A illustrates one auxiliary tool member of the prior art combination tire repair wrench twisted, the coupling head of the respective auxiliary tool member deformed.

FIG. 3B is a sectional view in an enlarged scale taken along line A-A of FIG. 3A.

FIG. 4 is a perspective view of a combination tire repair wrench according to the present invention.

FIG. 5 is shows the combination tire repair wrench extended out according to the present invention.

FIG. 5A is a sectional view taken along line B-B of FIG. 5.

FIG. 6 is a sectional view of the combination tire repair wrench according to the present invention.

FIG. 6A is a sectional view in an enlarged scale taken along line B-B of FIG. 6.

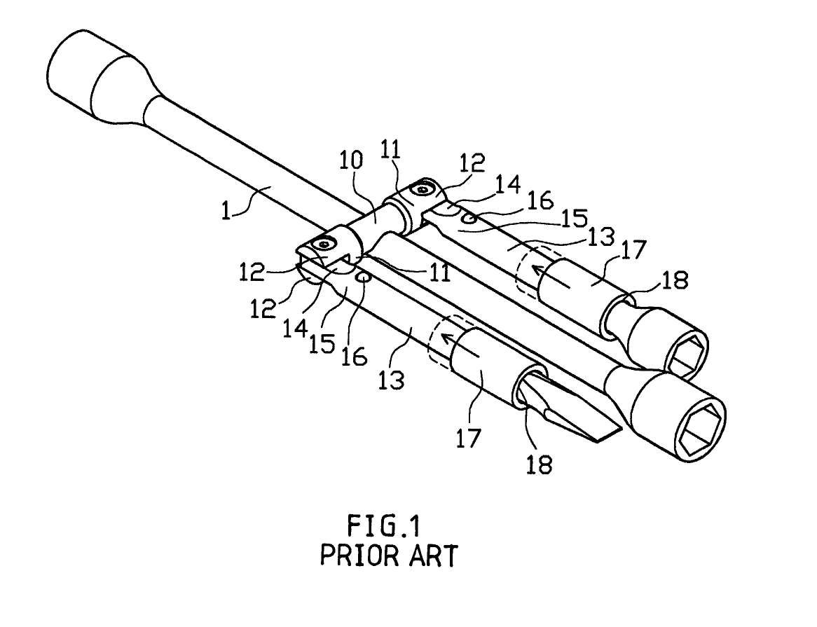

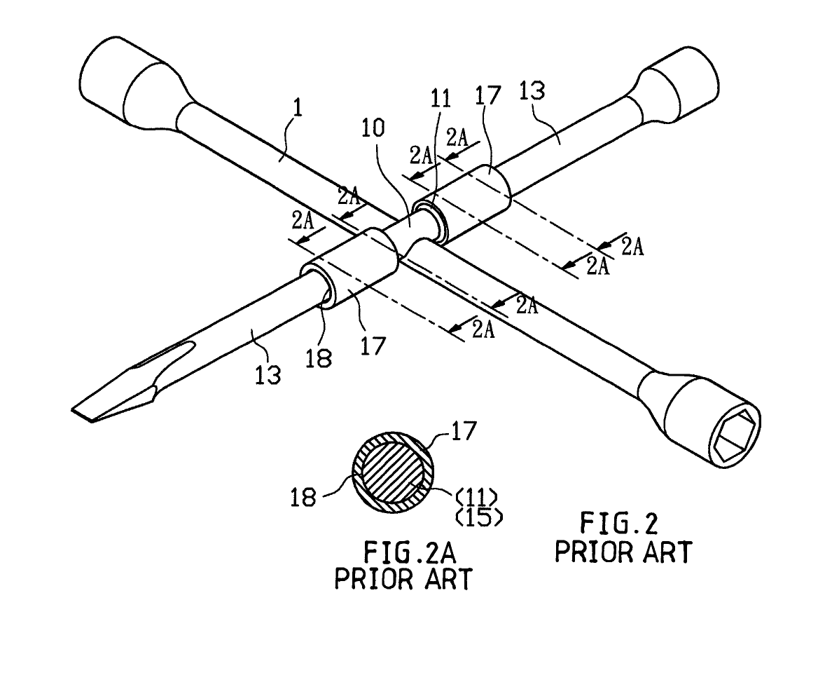

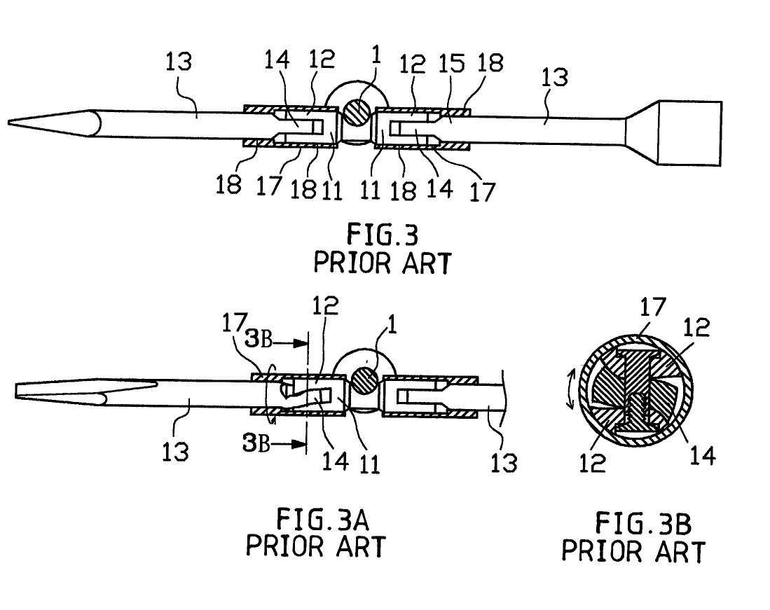

### DETAILED DESCRIPTION OF THE PREFERRED EMBODIMENT

Referring to FIGS. from 4 through 6, a combination tire repair wrench comprises a main wrench 2, which is same as that of the prior art design having two hexagonal sockets at the ends, a crossbar 20 welded to the middle part of the main wrench 2, two connecting rods 21 respectively fixedly provided at the ends of the crossbar 20, the connecting rods 21 each having a substantially U-shaped coupling portion 22, two auxiliary tool members 23 respectively pivoted to the U-shaped coupling portion 22 of each of the connecting rods 21, and two locking barrels 27 respectively slidably coupled to the auxiliary tool members 23 and adapted to lock the auxiliary tool members 23 in the extended position.

The main features of the present invention are outlined hereinafter. The connecting rods 21 each have a polygonal, for example, hexagonal cross section. The auxiliary members 23 each have a polygonal head 25, a coupling portion 24 axially extended from the polygonal head 25 and pivoted to the U-shaped coupling portion 22 of one connecting rod 21, and a spring-supported steel ball 26 provided in one side of the polygonal head 25. The locking barrels 27 have two hexagonal coupling portions W respectively disposed at two ends of the inner diameter thereof.

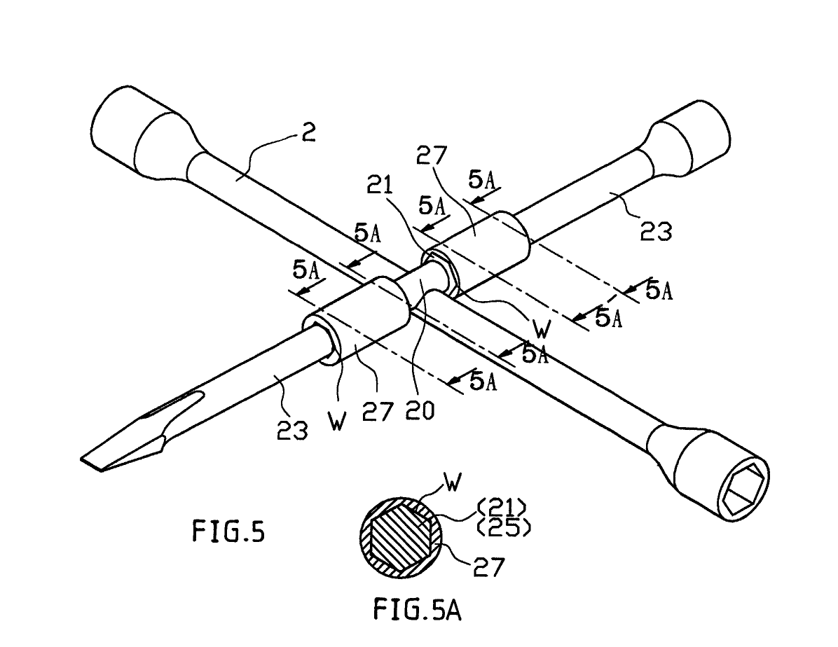

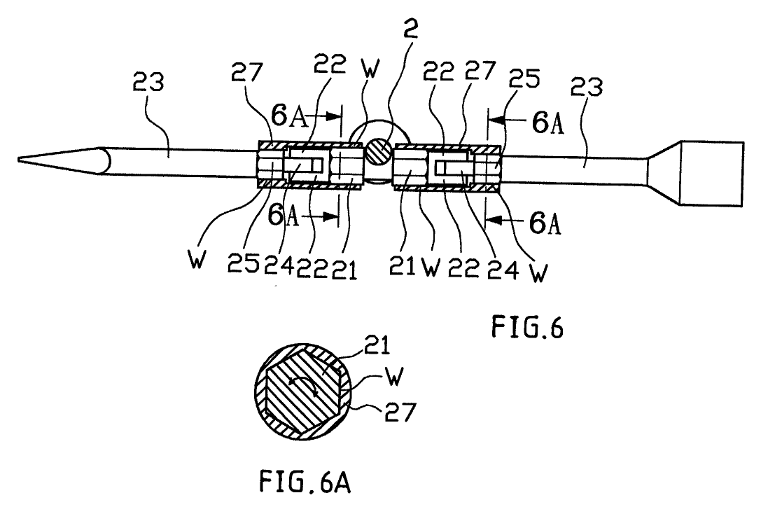

After the auxiliary tool members 23 have been extended out, the locking barrels 27 are moved to the locking position, keeping the hexagonal coupling portions W respectively engaged with the hexagonal outer diameter of each of the connecting rods 21 and the polygonal head 25 of each of the auxiliary tool members 23 (see FIGS. 5 and 5A).

Because the hexagonal coupling portions W of the locking barrels 27 are respectively engaged with the hexagonal outer diameter of each of the connecting rods 21 and the polygonal head 25 of each of the auxiliary tool members 23, the locking barrels 27 are turned with the connecting rods 21 and the auxiliary tool members 23 when driving one auxiliary tool member 23 to rotate the workpiece. Therefore, the locking barrels 27 well protect the coupling portion 24 of each of the auxiliary tool members 23 against twisting force.

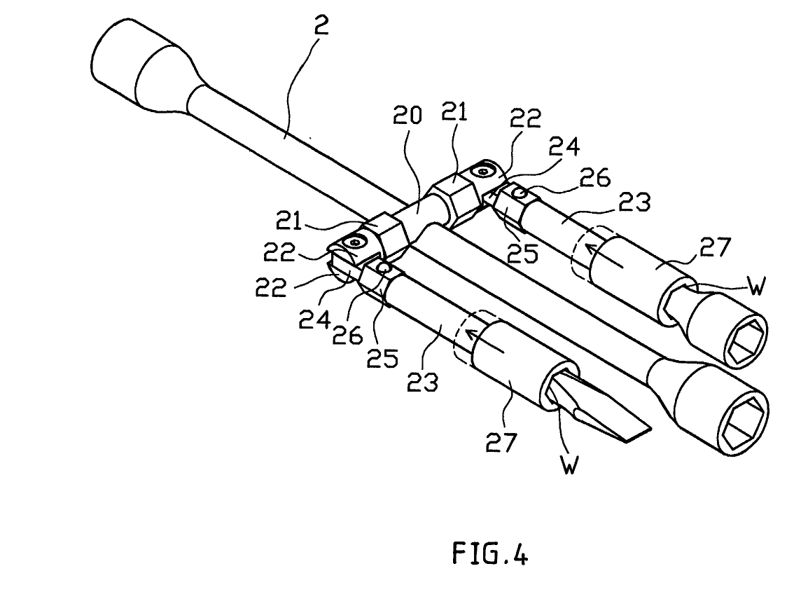

A prototype of combination tire repair wrench has been constructed with the features of FIGS. 4˜6. The combination tire repair wrench functions smoothly to provide all of the features discussed earlier.

It is to be understood that the drawings are designed for purposes of illustration only, and are not intended for use as a definition of the limits and scope of the invention disclosed.

What the invention claimed is:

1. A combination tire repair wrench comprising:
a main wrench;
a crossbar welded to a middle part of said main wrench in a crossed manner, two connecting rods respectively fixedly provided at two ends of said crossbar, said connecting rods each having a U-shaped coupling portion;
two auxiliary tool members respectively pivoted to the U-shaped coupling portion of each of said connecting rods and turned between a first position in parallel to said main wrench and a second position perpendicular to said main wrench;
two locking barrels respectively coupled to said auxiliary tool members and moved between a locking position where said locking barrels lock said auxiliary tool members in said second position, and an unlocking position where auxiliary tool members are unlocked and allowed to be turned between said first position and said second position;
wherein said connecting rods each have a polygonal peripheral wall, said auxiliary members each have a polygonal head, and a coupling portion axially extended from said polygonal head and pivoted to the U-shaped coupling portion of one of said connecting rods; said locking barrels each have two hexagonal coupling portions respectively disposed at two ends of the inner diameter thereof and adapted to engage the polygonal peripheral wall of one of said connecting rods and the polygonal head of one of said auxiliary tool members respectively.
